(19) United States
(12) Patent Application Publication
(10) Pub. No.: US 2024/0403889 A1
(43) Pub. Date: Dec. 5, 2024

(54) INFORMATION PROCESSING DEVICE, METHOD THEREOF, AND PROGRAM

(71) Applicant: SONY GROUP CORPORATION, TOKYO (JP)

(72) Inventors: HIROKI SAIJO, TOKYO (JP); TAKARA KASAI, TOKYO (JP); KIYOKAZU MIYAZAWA, TOKYO (JP); YOSHINAO SODEYAMA, TOKYO (JP)

(21) Appl. No.: 18/687,895

(22) PCT Filed: Mar. 14, 2022
(86) PCT No.: PCT/JP2022/011324

§ 371 Date: Feb. 29, 2024

(30) Foreign Application Priority Data
Sep. 21, 2021 (JP) 2021-153344

(51) Int. Cl. G06Q 30/015

(52) U.S. Cl. CPC G06Q 30/015

(57) ABSTRACT

The present technology relates to an information processing device, a method thereof, and a program that allow a customer service task with higher empathy to be implemented. An information processing device includes a communication unit that communicates with a plurality of customer service devices that performs a customer service task for a user, and a reception integration unit that allows a customer service device that is allowed to function as a character to perform an interaction based on information regarding the user and execute the customer service task for the user while switching the customer service device that is allowed to function as the character in such manner that any one of the plurality of customer service devices functions as one character defined for each user out of a plurality of characters. The present technology can be applied to a customer service providing system.

### TECHNICAL FIELD

The present technology relates to an information processing device, a method thereof, and a program, and especially relates to an information processing device, a method thereof, and a program capable of implementing a customer service task with higher empathy.

### BACKGROUND ART

In facilities such as a hotel and an inn, tasks are concentrated in the morning and evening hours, and employees need to leave temporality, so that it is not easy to secure a sufficient number of human resources.

Therefore, for example, a technology of performing a customer service task by a device other than a human has been proposed.

Specifically, for example, a technology of performing a front desk task of a hotel by a reception robot and a settlement procedure terminal (refer to, for example, Patent Document 1), and a technology of performing an interaction with a user, such as acceptance of an order for food and drink and provision of guide information by a personified character displayed on a terminal in a restaurant (refer to, for example, Patent Document 2) are proposed.

Furthermore, for example, a technology in which the same character is not simultaneously applied to a plurality of robots when a plurality of robots capable of representing a plurality of characters is operated (refer to, for example, Patent Document 3) is proposed.

### CITATION LIST

### Patent Document

Patent Document 1: Japanese Patent Application Laid-Open No. 2017-111489
Patent Document 2: Japanese Patent Application Laid-Open No. 2019-194800
Patent Document 3: Japanese Patent Application Laid-Open No. 2017-52075

### SUMMARY OF THE INVENTION

### Problems to be Solved by the Invention

In the customer service task, empathy is important to improve the satisfaction level of the customer (user), but with the above-described technology, it is difficult to implement the interaction with high empathy with the customer. That is, it has been difficult to implement the customer service task with high empathy with the above-described technology.

The present technology is achieved in view of such a condition and an object thereof is to implement the customer service task with higher empathy.

### Solutions to Problems

An information processing device according to one aspect of the present technology includes a communication unit that communicates with a plurality of customer service devices that performs a customer service task for a user, and a reception integration unit that allows a customer service device that is allowed to function as a character to perform an interaction based on information regarding the user and execute the customer service task for the user while switching the customer service device that is allowed to function as the character in such manner that any one of the plurality of customer service devices functions as one character defined for each user out of a plurality of characters.

An information processing method or a program according to one aspect of the present technology includes steps of communicating with a plurality of customer service devices that performs a customer service task for a user, and allowing a customer service device that is allowed to function as a character to perform an interaction based on information regarding the user and execute the customer service task for the user while switching the customer service device that is allowed to function as the character in such a manner that any one of the plurality of customer service devices functions as one character defined for each user out of a plurality of characters.

According to one aspect of the present technology, communication with a plurality of customer service devices that performs a customer service task for a user is performed, and an interaction based on information regarding the user is performed and the customer service task for the user is executed by a customer service device that functions as a character while the customer service device that is allowed to function as the character is switched in such a manner that any one of the plurality of customer service devices functions as one character defined for each user out of a plurality of characters.

### BRIEF DESCRIPTION OF DRAWINGS

FIG. 1 is a diagram illustrating a configuration example of a customer service providing system.

FIG. 2 is a diagram illustrating an example of a signature pause.

FIG. 3 is a diagram illustrating an appearance example of a front desk terminal.

FIG. 4 is a diagram illustrating a configuration example of the front desk terminal.

FIG. 5 is a diagram illustrating an appearance example of a front desk robot.

FIG. 6 is a diagram illustrating a configuration example of the front desk robot.

FIG. 7 is a flowchart illustrating front desk task control processing.

FIG. 8 is a flowchart illustrating front desk task execution processing.

FIG. 9 is a diagram illustrating an appearance example of a guide robot.

FIG. 10 is a diagram illustrating a configuration example of the guide robot.

FIG. 11 is a diagram illustrating a configuration example of a guest room terminal.

FIG. 12 is a diagram illustrating an appearance example of a room service robot.

FIG. 13 is a diagram illustrating a configuration example of the room service robot.

FIG. 14 is a diagram illustrating a configuration example of a computer.

### MODE FOR CARRYING OUT THE INVENTION

Hereinafter, embodiments to which the present technology is applied will be described with reference to the drawings.

### First Embodiment

### <Regarding Present Technology>

The present technology executes a customer service task while performing an interaction (communication) with a customer by a plurality of different customer service devices while switching the customer service device allowed to function as a character defined for each customer according to a content of the customer service task and the like.

Especially, in the present technology, an interaction with high empathy such as a chat is performed using empathy that has been difficult with existing AI and the like by using a plurality of customer service devices such as a robot device and a terminal capable of executing the customer service task, and an artificial intelligence (AI) character, so that it becomes possible to implement the customer service task with higher empathy.

Such present technology principally has the following features.

### Feature (1)

The present technology relates to a system including a plurality of customer service devices such as a robot device and a terminal, and an AI character program that implements an AI character being a virtual character that performs the customer service, the system capable of providing a plurality of customers with the customer service in a facility such as a hotel and an inn.

### Feature (2)

The AI character performs the customer service task for the customer by using an input/output of the robot device or the terminal on which the AI character is displayed.

Here, the input of the robot device or the terminal is, for example, an image of a customer and the like as a subject captured by a camera, a voice of the customer (utterance content of the customer) collected by a microphone and the like, and the output of the robot device or the terminal is utterance to the customer, information presented to the customer and the like.

Furthermore, the customer service task performed by the AI character, more specifically, the robot device or the terminal on which the AI character is displayed includes, for example, a front desk task, an in-facility guide task, a task to respond to a customer request, a room service task and the like.

At that time, the AI character behaves as if moving among a plurality of robot devices and terminals according to the content of a task to be executed, that is, the customer service task. In other words, the customer service device that functions as the AI character is switched in such a manner that the AI character is implemented by the customer service device corresponding to the customer service task to be executed out of the plurality of different customer service devices.

### Feature (3)

The content of the interaction between the AI character and the customer performed by the customer service device is taken over to another customer service device together with the AI character.

### Feature (4)

The display of the AI character differs depending on the type (type) of the customer service device, that is, the robot device and the terminal. For example, in the robot device in which the head is the display device, an image of the head of the AI character is displayed on the display device, and in a cart-type robot device, an image of the AI character imitating a figure riding on a cockpit is displayed.

### Feature (5)

Movement of the AI character is cooperated (linked) with the robot portion of the customer service device functioning as the AI character. That is, the movement of a part of the body of the AI character displayed as an image and the movement of the robot portion (manipulator) of the customer service device functioning as the AI character cooperate with each other, and the movement (behavior) of the AI character is expressed as a whole. Therefore, it is possible to improve expression of the movement and emotion of the AI character.

Furthermore, features such as a movement habit and a signature pose are different for each AI character. By not only displaying the image but also expressing the AI character with the entire body of the customer service device, it is possible to make it easy for the customer who receives a customer service to recognize that the AI character is the same.

### Feature (6)

The movement of the AI character, that is, switching of the customer service device allowed to function as the AI character is performed by, for example, a procedure by proximity communication or communication via a network, and the same AI character is not displayed on a plurality of customer service devices at the same time. Furthermore, at the same time as the movement of the AI character, the voice input/output of the character in the customer service device is also switched.

### <Configuration Example of Customer Service Providing System>

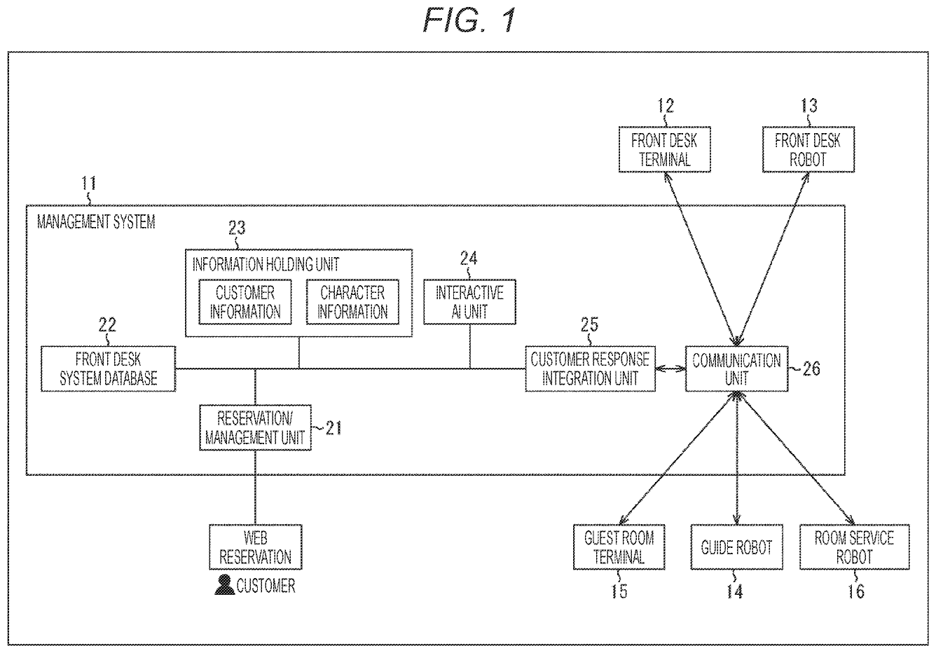

FIG. 1 is a diagram illustrating a configuration example of one embodiment of a customer service providing system to which the present technology is applied.

The customer service providing system illustrated in FIG. 1 provides a user (customer) with a service regarding a customer service task, more specifically, a service regarding use of an accommodation facility such as a hotel and an inn.

The customer service providing system includes a management system 11, a front desk terminal 12, a front desk robot 13, a guide robot 14, a guest room terminal 15, and a room service robot 16.

The management system 11 includes an information processing device such as a server, for example. Note that, the management system 11 may include one information processing device or may include a plurality of information processing devices.

The management system 11 implements provision of the service by various types of customer service tasks to the customer as the user of the accommodation facility by controlling the front desk terminal 12 to the room service robot 16, which are customer service devices arranged in the accommodation facility such as the hotel and the inn.

The customer service task herein includes at least any one of a front desk task, an in-facility guide task, a task to respond to a customer request, or a room service task.

The management system 11 includes a reservation/management unit 21, a front desk system database 22, an information holding unit 23, an interactive AI unit 24, a customer response integration unit 25, and a communication unit 26. Furthermore, the reservation/management unit 21 to the customer response integration unit 25 are connected to one another by a bus, by wire, wirelessly and the like.

The reservation/management unit 21 performs processing regarding reservation of accommodation of the customer on the WEB and the like and management.

The front desk system database 22 records customer accommodation information that is information regarding the accommodation of the customer, and supplies the customer accommodation information to the reservation/management unit 21, the interactive AI unit 24, the customer response integration unit 25 and the like as necessary.

For example, the customer accommodation information includes information such as a reservation number, name and sex of the customer and a companion, an address of the customer, a plan used by the customer, accommodation date, the number of accommodation days, the number of users, a guest room allocated to the customer, whether or not the customer eats, and meal time obtained at the time of reservation of use of the accommodation facility by the customer and the like.

The information holding unit 23 holds (records) customer information and character information, and supplies the customer information and character information to the interactive AI unit 24 and the customer response integration unit 25 as necessary.

The customer information is information regarding an individual customer. For example, the customer information includes at least any one piece of information out of the name, age, sex, and address of the customer, presence or absence of an allergic response, customer request information, customer preference information, character selection information, and customer interaction information obtained by an interaction with the customer by an AI character.

The customer request information is, for example, information indicating a customer request to the accommodation facility such as provision of information regarding sightseeing around the accommodation facility and the like.

The customer preference information is, for example, information regarding customer preference (taste) such as preference for a dish of the customer and preference of smoking.

The character selection information is information indicating the AI character selected by the customer out of a plurality of AI characters, in other words, the AI character defined for each customer obtained at the time of reservation of accommodation (use) by the customer and the like.

Note that, for example, information regarding preference for the AI character of the customer such as preference for an animal character may be included in the customer preference information, and the AI character may be customized for each customer on the basis of the customer preference information.

The customer interaction information can include not only information obtained by the interaction performed at the time of current accommodation facility use (at the time of service use) by the customer but also information obtained by the interaction performed at the time of past service use by the customer. It may be said that this customer interaction information includes, for example, information regarding an interest of the customer and the like.

Furthermore, the information holding unit 23 holds the character information for each AI character.

The character information includes information regarding the AI character, that is, information for implementing the AI character, such as appearance information, interaction voice information, and behavior information.

Here, the appearance information is an image (image information) of an appearance of the AI character, model information for constructing an image of the AI character and the like.

Furthermore, the interaction voice information is information regarding a voice (utterance) of the AI character at the time of interaction with the customer, such as a manner of speaking (characteristic ending, intonation and the like), a voice quality, a tone, and a signature phrase of the AI character.

The behavior information is information indicating a behavior of the AI character, that is, a feature (habit) of a manner of movement, a gesture, a signature pose and the like.

By holding the character information for each AI character in the information holding unit 23, it is possible to allow the AI characters to have different personalities, respectively. That is, the appearance, the voice quality (sound quality), the manner of speaking, the behavior (movement) and the like can be made different for each of the plurality of AI characters.

The interactive AI unit 24 generates information for implementing the interaction with the customer on the basis of the customer information and the character information recorded in the information holding unit 23 and the customer accommodation information recorded in the front desk system database 22 by executing a recorded AI character program.

That is, the interactive AI unit 24 functions as a generation unit and generates an AI character display image, an AI character output voice, and AI character operation information as the information for implementing the interaction with the customer on the basis of information regarding the customer such as the customer information and the customer accommodation information, and the character information.

The AI character display image is an image (still image or moving image (video)) of a part of a body such as a head of the AI character that serves a customer or an entire body of the AI character.

The AI character output voice is the voice of the utterance of the AI character when the interaction with the customer is performed at the time of customer service and the like, that is, a voice output by the AI character.

The AI character operation information is information indicating an operation of the AI character when performing a customer service task, more specifically, the operation of the customer service device that functions as the AI character. In other words, the AI character operation information is instruction information that specifies the operation that the AI character should perform at the time of customer service task and issues an instruction to execute the operation.

The customer response integration unit 25 controls an entire operation of the management system 11.

For example, the customer response integration unit 25 supplies the AI character display image, the AI character output voice, and the AI character operation information generated by the interactive AI unit 24 to the communication unit 26 to transmit to the customer service device. Therefore, the customer response integration unit 25 allows the customer service device to function as a specific AI character, and allows the customer service device to perform the interaction based on the information regarding the customer to execute the customer service task for the customer.

At that time, the customer response integration unit 25 allows each of the customer service devices to execute the customer service task while switching the customer service device allowed to function as the AI character in such a manner that only one of the plurality of customer service devices, that is, the front desk terminal 12 to the room service robot 16 functions as one specific AI character defined by the customer.

In other words, the customer response integration unit 25 receives the AI character from the customer service device that finishes the customer service task, or moves (transfers) the AI character to the customer service device that executes the customer service task next, thereby taking over the AI character.

Note that, the takeover of the AI character is basically performed via the customer response integration unit 25, but in some cases, communication may be performed between the customer service devices, and the takeover of the AI character may be directly performed between the customer service devices.

The communication unit 26 performs proximity communication and communication via a network with the front desk terminal 12 to the room service robot 16, which are the customer service devices that perform various customer service tasks located in the accommodation facility.

For example, the communication unit 26 transmits the AI character display image, the AI character output voice, and the AI character operation information supplied from the customer response integration unit 25 to the customer service device, and receives various types of information transmitted from the customer service device and supplies the same to the customer response integration unit 25.

Furthermore, in the customer service providing system, the front desk terminal 12 to the room service robot 16, which are the customer service devices, perform various customer service tasks for the customer.

At least one customer service device including a manipulator is included in the plurality of customer service devices. For example, out of the customer service devices, the manipulator is provided on the front desk robot 13 and the guide robot 14, which are the robot devices.

Furthermore, the plurality of customer service devices includes the customer service devices that perform customer service tasks (tasks) of different types.

The front desk terminal 12 includes, for example, an information processing device such as a computer installed at the front desk of the accommodation facility, and performs the front desk task such as check-in.

The front desk robot 13 includes, for example, a robot device disposed at the front desk of the accommodation facility, and performs the front desk task such as check-in.

The front desk robot 13 basically performs the front desk task similar to that of the front desk terminal 12, but since the front desk robot 13 includes the manipulator, this can execute transfer of a document, a room key and the like, which cannot be performed by the front desk terminal 12.

The guide robot 14 includes, for example, a robot device capable of moving in the accommodation facility, and performs the in-facility guide task such as guidance (guidance) of the customer to the guest room.

The guest room terminal 15 includes an information processing device such as a computer installed in the guest room, and performs the customer response task in response to the customer request, such as information provision and room service acceptance.

The room service robot 16 includes, for example, a robot device capable of moving in the facility, and performs the room service task of delivering (serving) food and drink and the like of the room service to the guest room.

In the customer service providing system as described above, the communication unit 26 communicates with the front desk terminal 12 to the room service robot 16, which are the customer service devices, and the customer response integration unit 25 controls these customer service devices to provide the service to the customer.

Here, a specific example of a principal flow of the customer service provided by the customer service providing system will be described.

First, the customer inputs required information from his/her own terminal and the like to make a reservation for an accommodation via the WEB and the like. At that time, the customer appropriately inputs required information such as the name, age, sex, address, request, and preference, and also selects the AI character to respond during the stay.

Then, on the basis of the information input by the customer at the time of reservation, the reservation/management unit 21 performs allocation and the like of the guest room to the customer, and generates the customer accommodation information and supplies the same to the front desk system database 22 to record the customer accommodation information.

Furthermore, the reservation/management unit 21 generates the customer information on the basis of the information input by the customer at the time of reservation and supplies the same to the information holding unit 23 to record the customer information, or updates the customer information already recorded in the information holding unit 23 on the basis of the information input by the customer at the time of reservation.

At that time, for example, the reservation/management unit 21 determines (selects) the AI character to be in charge of the customer according to the selection of the customer, and generates the character selection information indicating a determination result.

Note that, some information such as the customer request information and preference information included in the customer information may be obtained not only at the time of reservation but also by the interaction with the AI character after reservation such as at the time of check-in.

When the reservation is completed and the customer arrives at the front desk on the accommodation date, the customer response integration unit 25 allows the front desk terminal 12 or the front desk robot 13 to display the AI character selected by the customer, that is, the AI character in charge (the image of the AI character) in charge of the customer.

Therefore, the front desk terminal 12 or the front desk robot 13 functions as the AI character. That is, the AI character moves (is transferred) to the front desk terminal 12 or the front desk robot 13.

At that time, the customer response integration unit 25 allows the customer service device to display the image of the entire body of the AI character or display the image of a part of the body of the AI character according to the type (type) of the customer service device such as the front desk terminal 12 that functions as the AI character, the position where the character display unit is provided in the customer service device and the like. That is, different images of the same AI character are displayed in each of the plurality of customer service devices.

Note that, in a case where the customer service device such as the front desk terminal 12 is allowed to function as the AI character, the customer response integration unit 25 not only allows the customer service device to display the AI character but also allows the same to output an interaction voice with the voice quality or the manner of speaking determined for the AI character, and allows the same to operate to behave like the AI character on the basis of character information. Therefore, not only the appearance but also the voice quality, the manner of speaking, and the behavior (movement) express the AI character characteristic.

The customer response integration unit 25 allows the front desk terminal 12 or the front desk robot 13, which become the AI character, to execute the front desk task such as the check-in, that is, acceptance of accommodation by the interaction with the customer.

When the check-in is completed, the customer response integration unit 25 moves the display of the AI character from the front desk terminal 12 or the front desk robot 13 to the guide robot 14. That is, the AI character is taken over (transferred) from the front desk terminal 12 or the front desk robot 13 to the guide robot 14 by the customer response integration unit 25.

The guide robot 14 that becomes the AI character moves in the facility while performing the interaction with the customer according to the control of the customer response integration unit 25, thereby performing, as the in-facility guide task, the facility guidance to the charged customer and the guidance (guidance) to the guest room where the customer stays.

At that time, the interactive AI unit 24 generates the AI character output voice on the basis of, for example, information obtained at the time of reservation or check-in, that is, the customer request information, preference information and the like included in the customer information. Therefore, a chat and the like (communication) using empathy with the customer, that is, the interaction with high empathy is implemented, and the degree of empathy is improved.

Especially, in the customer service providing system, the same AI character continues to serve the customer, and the AI character output voice is generated by using not only the information obtained at the time of reservation but also the information obtained at the time of check-in and the interaction after the check-in. That is, even if the customer service device that serves the customer changes, the AI character in charge and the content of the interaction with the customer performed so far are directly taken over to the customer service device that serves the customer next.

Therefore, it is possible to be put into a state of continuously having a conversation with the same AI character, and it is possible to perform a more empathic interaction with a topic preferred by the customer or a topic regarding information required by the customer. As a result, it is possible to implement the customer service task with higher empathy.

Furthermore, when the in-facility guide task by the guide robot 14 is completed, the customer response integration unit 25 moves the display of the AI character from the guide robot 14 to the guest room terminal 15.

That is, the customer response integration unit 25 allows the guest room terminal 15 to continuously display the AI character and allows the guest room terminal 15 to perform the customer response task while the customer stays in the guest room.

Furthermore, for example, when the customer orders the room service by the interaction with the guest room terminal 15, the customer response integration unit 25 temporarily moves the AI character from the guest room terminal 15 to the room service robot 16, and allows the room service robot 16 to perform the room service task.

More specifically, for example, when delivery of the ordered food and drink and the like is started by the room service robot 16, the AI character moves (is transferred) to the room service robot 16.

Furthermore, for example, while the room service robot 16 is moving for delivery to the guest room, an image captured by the room service robot 16 or an image captured by a camera in the facility is displayed on the guest room terminal 15. Therefore, a state of delivery (transportation) of the food and drink and the like by the room service robot 16 is presented to the customer by the guest room terminal 15.

When the delivery of the room service is completed, the AI character is then transferred from the room service robot 16 to the guest room terminal 15.

Here, the customer service device and the AI character that moves between a plurality of customer service devices will be described.

The appearance, behavior, manner of speaking and the like of the AI character are determined by the character information recorded for the AI character.

Since the character information different for each AI character is recorded in the information holding unit 23, the respective AI characters have different personalities. That is, the appearance, the movement on the display, the movement in cooperation with the robot, the voice (voice quality or tone), the manner of speaking, the habit of the movement, the signature pose and the like are different for each AI character.

Therefore, even if the AI character moves between a plurality of customer service devices, it is easy to recognize that the AI character is the same one AI character as viewed from the customer.

The AI character executes the customer service task (task) while performing an interaction and behavior (movement) based on the customer information and the customer accommodation information recorded for each customer and the character information of the AI character selected by the customer, thereby building an excellent relationship with the customer.

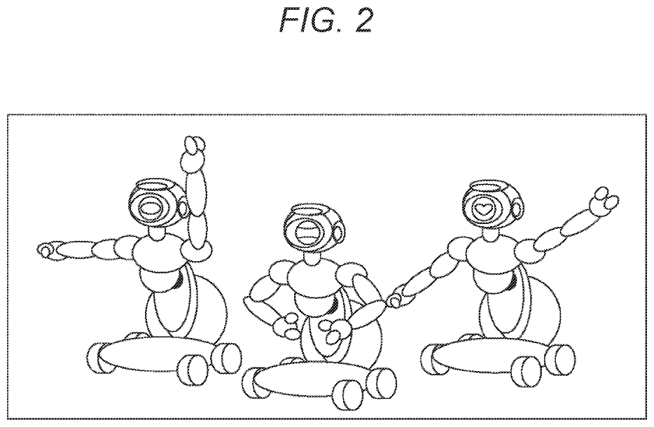

Furthermore, for example, as illustrated in FIG. 2, the AI character performs the signature pose together with greetings and the like at an appropriate timing such as at the start or end of the customer service task.

In the example illustrated in FIG. 2, three robot devices functioning as AI characters different from one another are illustrated, and different signature poses are performed by the three robot devices, respectively.

For example, in the drawing, the signature pose of the robot device on the left side is a pose (posture) in which the left arm is raised straight and the right arm is extended just beside.

In this manner, by performing different signature poses for each AI character, it is possible to make the customer more easily recognize the AI character in charge and make the AI character familiar.

The customer information obtained for each customer is accumulated and managed by the information holding unit 23. By updating such customer information on the basis of the information obtained at the time of reservation or information obtained by the interaction with the AI character at the time of visiting to the accommodation facility, it is possible to provide a fresh topic to the customer.

Furthermore, by updating the customer information, that is, by accumulating newly obtained information, it is possible to have a closer interaction with a regular customer of the accommodation facility by using information obtained at the time of current or past service use, and to build a more excellent relationship.

In addition, for the AI character, it is easy to collaborate with a well-known existing character, change the appearance according to the season and the like, and it is possible to improve the ability to attract guests of the accommodation facility by such collaboration, change in appearance and the like.

### <Regarding Front Desk Terminal>

Subsequently, the front desk terminal 12 to the room service robot 16, which are the customer service devices, will be described in more detail.

First, the front desk terminal 12 will be described.

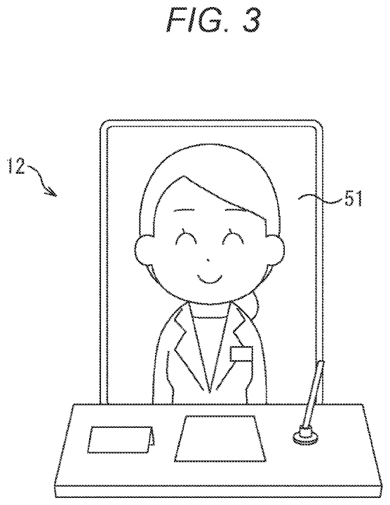

The front desk terminal 12 has an appearance as illustrated in FIG. 3, for example.

In this example, the front desk terminal 12 includes a character display unit 51 including a display and the like, and the AI character display image, that is, the image of the AI character is displayed on the character display unit 51. Especially, here, a chest and its upper portion of the AI character, that is, the chest and the head of the AI character are displayed as the AI character display image.

The customer performs a procedure required for check-in (acceptance) for accommodation through the interaction with the displayed AI character.

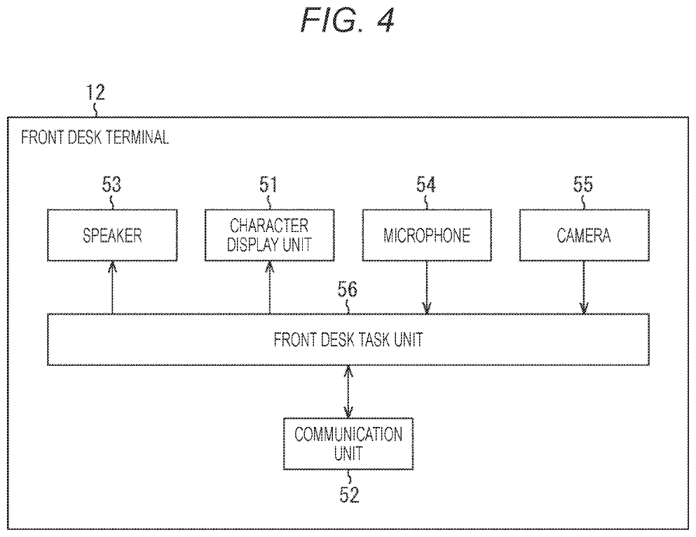

FIG. 4 is a diagram illustrating a functional configuration example of the front desk terminal 12. Note that, in FIG. 4, portions corresponding to those in a case of FIG. 3 are denoted by the same reference signs, and the description thereof will be omitted as appropriate.

In this example, the front desk terminal 12 includes the character display unit 51, a communication unit 52, a speaker 53, a microphone 54, a camera 55, and a front desk task unit 56.

The communication unit 52 supplies the AI character display image and the AI character output voice transmitted from the management system 11 to the front desk task unit 56, and transmits an image of a face of the customer and a voice of the customer supplied from the front desk task unit 56 to the management system 11.

The character display unit 51 displays the AI character display image supplied from the front desk task unit 56, that is, the AI character selected by the customer. The speaker 53 outputs the AI character output voice supplied from the front desk task unit 56.

The microphone 54 collects the voice of the surrounding customer (hereinafter, also referred to as a customer voice) and supplies the same to the front desk task unit 56. The camera 55 captures an image of the customer as a subject (hereinafter, also referred to as a customer face image) and supplies the same to the front desk task unit 56.

The front desk task unit 56 performs the front desk task by controlling an entire operation of the front desk terminal 12. That is, the front desk task unit 56 cooperates with the customer response integration unit 25 of the management system 11 to perform the interaction and the like with the customer, thereby performing the front desk task.

### <Regarding Front Desk Robot>

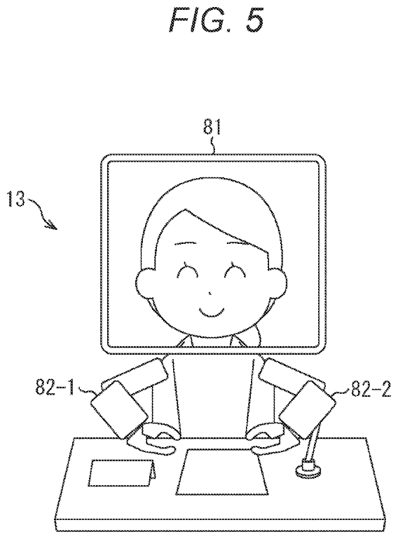

The front desk robot 13 has an appearance as illustrated in FIG. 5, for example.

In this example, the front desk robot 13 includes a character display unit 81 including a display and the like, and the AI character display image is displayed on the character display unit 81.

Especially, here, the head of the AI character is displayed as the AI character display image, and the AI character display image and a portion below the head of the front desk robot 13 form the AI character as a whole.

Furthermore, the front desk robot 13 includes a manipulator 82-1 and a manipulator 82-2, which are machine portions functioning as arms, hands and the like of the AI character. Note that, hereinafter, in a case where the manipulator 82-1 and the manipulator 82-2 are not especially required to be distinguished from each other, they will also be simply referred to as the manipulators 82.

With the front desk robot 13, the behavior of the AI character is effectively implemented by cooperation (linkage) between the display of the AI character display image and movement of the manipulator 82. That is, the customer response integration unit 25 allows the display of the AI character display image and the movement of the manipulator 82 in the front desk robot 13 to cooperate with each other according to a task execution instruction to be described later, thereby implementing the behavior for each AI character.

The front desk robot 13 basically performs the front desk task similar to that of the front desk terminal 12, but since this includes the manipulator 82, this can perform the transfer of the document, room key and the like, which cannot be performed by the front desk terminal 12.

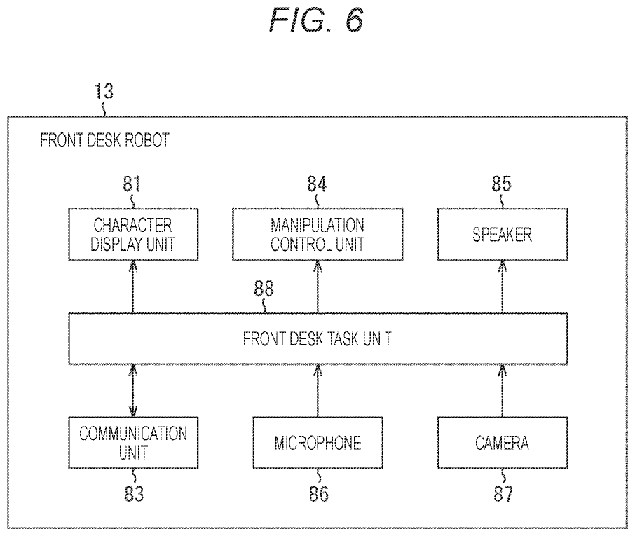

FIG. 6 is a diagram illustrating a functional configuration example of the front desk robot 13. Note that, in FIG. 6, portions corresponding to those in a case of FIG. 5 are denoted by the same reference signs, and the description thereof will be omitted as appropriate.

In this example, the front desk robot 13 includes the character display unit 81, a communication unit 83, a manipulation control unit 84, a speaker 85, a microphone 86, a camera 87, and a front desk task unit 88.

The communication unit 83 supplies the AI character display image, the AI character output voice, and the AI character operation information transmitted from the management system 11 to the front desk task unit 88, and transmits the customer face image and the customer voice supplied from the front desk task unit 88 to the management system 11.

The manipulation control unit 84 allows the front desk robot 13 to perform a predetermined operation by driving the manipulator 82 on the basis of the AI character operation information supplied from the front desk task unit 88.

The speaker 85 outputs the AI character output voice supplied from the front desk task unit 88. The microphone 86 collects the voice of the surrounding customer as the customer voice and supplies the same to the front desk task unit 88. The camera 87 captures the customer face image with the customer as the subject and supplies the same to the front desk task unit 88.

The front desk task unit 88 performs the front desk task by controlling an entire operation of the front desk robot 13. That is, the front desk task unit 88 cooperates with the customer response integration unit 25 of the management system 11 to perform the interaction with the customer and the like, thereby performing the front desk task.

### <Description of Front Desk Task Control Processing>

Subsequently, front desk task control processing executed when the management system 11 allows the front desk robot 13 to perform the front desk task will be described.

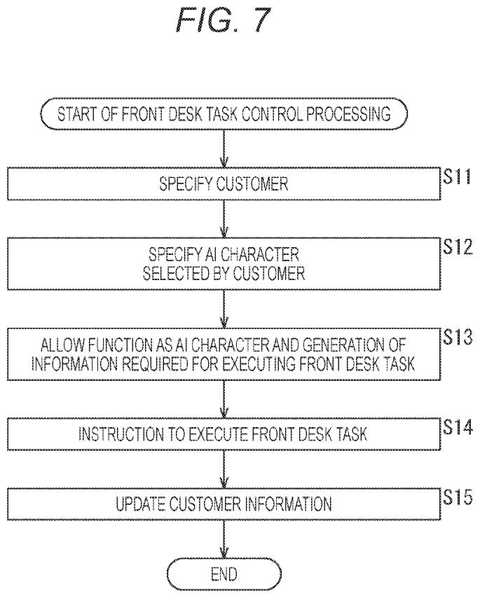

That is, hereinafter, the front desk task control processing performed by the management system 11 will be described with reference to a flowchart in FIG. 7. The front desk task control processing starts, for example, when arrival report information indicating that the customer arrives at the front desk of the accommodation facility is supplied from the front desk robot 13 to the customer response integration unit 25.

At step S11, on the basis of the arrival report information supplied from the front desk robot 13 via the communication unit 26, the customer response integration unit 25 specifies the customer to whom the front desk task should be performed from now on.

For example, the arrival report information includes information capable of specifying the customer such as the name of the customer and the reservation number at the time of reservation. On the basis of the arrival report information, the customer response integration unit 25 specifies the customer who arrives at the front desk with reference to the customer accommodation information recorded in the front desk system database 22. Therefore, the information regarding accommodation such as the name of the customer, a use plan, and the guest room where the customer stays is specified.

At step S12, the customer response integration unit 25 specifies the AI character selected by the customer with reference to the character selection information included in the customer information of the customer specified at step S11 recorded in the information holding unit 23.

At step S13, the customer response integration unit 25 allows the interactive AI unit 24 to generate information required for allowing the front desk robot 13 to function as the AI character selected by the customer and allowing the front desk robot 13 to execute the front desk task.

Here, the AI character display image, the AI character output voice, and the AI character operation information are generated as information required for allowing the front desk robot 13 to function as the AI character and to execute the front desk task.

For example, the customer response integration unit 25 supplies the information indicating the customer specified at step S11 and the information indicating the AI character specified at step S12 to the interactive AI unit 24, and instructs the same to generate the AI character display image, the AI character output voice, and the AI character operation information.

Then, the interactive AI unit 24 reads the customer accommodation information of the customer specified at step S11 from the front desk system database 22 in response to the instruction from the customer response integration unit 25. Furthermore, the interactive AI unit 24 reads the customer information of the customer specified at step S11 from the information holding unit 23, and also reads the character information of the AI character specified at step S12 from the information holding unit 23.

Then, the interactive AI unit 24 executes the AI character program to generate the AI character display image, the AI character output voice, and the AI character operation information for allowing the front desk task to be performed by performing the interaction with the customer on the basis of the read customer accommodation information, customer information, and character information.

In this case, for example, the interactive AI unit 24 generates an image of the head (face) of the AI character to be displayed on the character display unit 81 as the AI character display image. An expression and the like of the face of the AI character based on the AI character display image changes depending on the content of the interaction by the AI character output voice.

Furthermore, for example, the interactive AI unit 24 generates the AI character output voice for implementing the interaction (conversation) including not only the interaction of the content required for the execution of the front desk task such as check-in but also a chat of a content based on the customer preference information included in the customer information, customer interaction information obtained at the time of past use of the customer and the like as appropriate. The AI character output voice is generated by an interaction generation model learned in advance and the like implemented by, for example, the AI character program.

Moreover, the interactive AI unit 24 generates the AI character operation information for allowing the behavior, that is, the movement that matches (corresponds to) the AI character output voice to be performed. The AI character operation information is information that specifies the movement of the manipulator 82 of the front desk robot 13.

The interactive AI unit 24 supplies the generated AI character display image, AI character output voice, and AI character operation information to the customer response integration unit 25.

At step S14, the customer response integration unit 25 instructs the front desk robot 13 to execute the front desk task.

For example, the customer response integration unit 25 generates the task execution instruction that includes the AI character display image, the AI character output voice, and the AI character operation information supplied from the interactive AI unit 24 and instructs the front desk robot 13 to execute the front desk task, and supplies the same to the communication unit 26.

The communication unit 26 transmits the task execution instruction supplied from the customer response integration unit 25 to the front desk robot 13. Therefore, the customer response integration unit 25 performs control to allow the front desk robot 13 to function as the specific AI character defined by the customer, allow the front desk robot 13 that becomes the AI character to perform the interaction with the customer, and allow the same to execute the front desk task.

The front desk robot 13 performs the front desk task in response to the task execution instruction. At that time, since the front desk robot 13 appropriately transmits the customer voice and the customer face image obtained during the customer service of the front desk task, the communication unit 26 receives the transmitted customer voice and customer face image and supplies the same to the customer response integration unit 25.

Furthermore, the customer response integration unit 25 supplies the customer voice and the customer face image supplied from the communication unit 26 to the interactive AI unit 24, and issues an instruction to generate the AI character display image, the AI character output voice, and the AI character operation information for the interaction performed several times with the customer until the front desk task is completed.

Then, the interactive AI unit 24 extracts the content of the interaction with the customer during the customer service, especially the content of the utterance by the customer, by performing voice processing such as voice recognition on the customer voice supplied from the customer response integration unit 25. Furthermore, the interactive AI unit 24 performs image recognition processing and the like on the customer face image supplied from the customer response integration unit 25 to specify the expression of the customer, that is, the customer emotion during the customer service.

Then, the interactive AI unit 24 generates the AI character display image, the AI character output voice, and the AI character operation information by using not only the customer accommodation information, the customer information, and the character information but also the customer voice and the customer face image obtained during the customer service, that is, the interaction content with the customer and the expression of the customer during the customer service, and supplies the same to the customer response integration unit 25.

The customer response integration unit 25 generates the task execution instruction including the AI character display image, the AI character output voice, and the AI character operation information newly generated by the interactive AI unit 24 in this manner to supply to the communication unit 26, and transmits the task execution instruction to the front desk robot 13.

When executing the front desk task, since the task execution instruction and the customer voice and customer face image are given and received several times, so that the interaction between the front desk robot 13 and the customer is implemented, the customer service regarding the front desk task is performed.

When the front desk task is completed, the task completion report is transmitted from the front desk robot 13, so that the communication unit 26 receives the task completion report transmitted from the front desk robot 13 and supplies the same to the customer response integration unit 25.

When the task completion report is supplied from the communication unit 26, the customer response integration unit 25 instructs the interactive AI unit 24 to stop generating information required for executing the front desk task, and stops supplying the task execution instruction to the front desk robot 13.

Therefore, the customer response integration unit 25 controls the front desk robot 13 so as not to function as the AI character in charge of the customer. In other words, the AI character is transferred from the front desk robot 13 to the customer response integration unit 25.

At step S15, the interactive AI unit 24 updates the customer information recorded in the information holding unit 23 on the basis of the customer voice and the customer face image obtained during the customer service of the front desk task.

Specifically, for example, the interactive AI unit 24 updates the customer interaction information by adding the content of the interaction with the customer extracted from the customer voice during the customer service, the expression of the customer specified from the customer face image and the like to the customer interaction information included in the customer information. Therefore, for example, information such as a topic that the customer is interested in and a sightseeing destination of the customer is added to the customer interaction information.

Furthermore, for example, the interactive AI unit 24 may update the customer preference information, request information and the like included in the customer information on the basis of the information such as customer meal preference or request obtained from the customer voice during the customer service.

Moreover, for example, in a case where there is specification of the meal time, whether or not to use various services and the like from the customer at the time of customer service for the front desk task, the interactive AI unit 24 supplies the information of the meal time specified by the customer and the like obtained from the customer voice to the customer response integration unit 25. Then, the customer response integration unit 25 updates the customer accommodation information of the customer recorded in the front desk system database 22 on the basis of the information supplied from the interactive AI unit 24.

When the front desk task is completed and the customer information is updated, the front desk task control processing ends.

As described above, the management system 11 generates the task execution instruction, allows the front desk robot 13 to function as the AI character defined by the customer, and allows the front desk robot 13 to execute the front desk task.

Especially, in the management system 11, by allowing the AI character defined by the customer to perform the customer service and generating the information required for executing the front desk task on the basis of the customer accommodation information, the customer information, and the character information, it is possible to implement the customer service task with higher empathy.

### <Description of Front Desk Task Execution Processing>

Furthermore, when the front desk task control processing described with reference to FIG. 7 is started, the front desk robot 13 performs the front desk task execution processing.

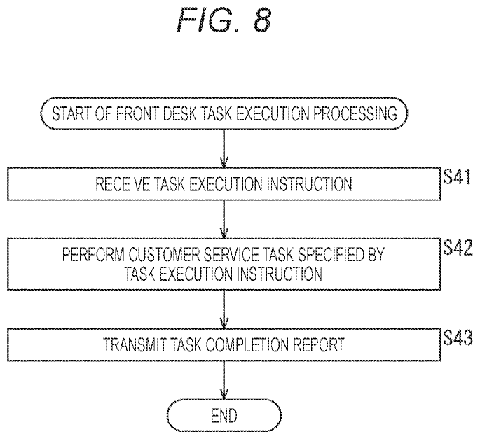

Hereinafter, the front desk task execution processing performed by the front desk robot 13 will be described with reference to a flowchart in FIG. 8.

At step S41, the communication unit 83 receives the task execution instruction transmitted from the management system 11 and supplies the same to the front desk task unit 88. The task execution instruction is generated at step S14 in FIG. 7.

At step S42, the front desk task unit 88 allows the entire front desk robot 13 to function as the AI character in accordance with the task execution instruction supplied from the communication unit 83, and performs the customer service task specified by the task execution instruction.

That is, the front desk task unit 88 supplies the AI character display image included in the task execution instruction to the character display unit 81 to display, and supplies the AI character output voice included in the task execution instruction to the speaker 85 to output.

Furthermore, the front desk task unit 88 supplies the AI character operation information included in the task execution instruction to the manipulation control unit 84, and instructs the same to drive the manipulator 82. The manipulation control unit 84 allows the front desk robot 13 to perform the operation of the AI character by driving the manipulator 82 on the basis of the AI character operation information supplied from the front desk task unit 88.

Therefore, the entire front desk robot 13 becomes the AI character, and the front desk robot 13 performs the customer service for the front desk task for the customer.

That is, the front desk robot 13 expresses the characteristic movement (behavior) of the AI character by the manipulator 82 while allowing the character display unit 81 to display the face of the AI character, and outputs the voice of the interaction for performing the customer service from the speaker 85 in the manner of speaking of the AI character. Furthermore, for example, the manipulator 82 drives according to the control of the manipulation control unit 84, and transfers the document, room key and the like as necessary.

At the time of customer service for the front desk task, the front desk task unit 88 obtains the customer voice from the microphone 86 as necessary, obtains the customer face image from the camera 87, and supplies the customer voice and the customer face image to the communication unit 83.

The communication unit 83 transmits the customer voice and the customer face image supplied from the front desk task unit 88 to the management system 11 as a feed back to the interaction with the customer, that is, the utterance to the customer.

Furthermore, when a new task execution instruction is transmitted from the management system 11 during the customer service of the front desk task, the communication unit 83 receives the task execution instruction and supplies the same to the front desk task unit 88. The front desk task unit 88 controls the character display unit 81, the speaker 85 and the like to continuously perform the front desk task on the basis of the task execution instruction newly supplied from the communication unit 83.

When the communication with the customer is performed as described above and the front desk task by the interaction and the like is completed, the front desk task unit 88 generates the task completion report indicating that the front desk task is completed and supplies the same to the communication unit 83.

At step S43, the communication unit 83 transmits the task completion report supplied from the front desk task unit 88 to the management system 11, and the front desk task execution processing ends.

When the front desk task execution processing ends, the front desk task unit 88 stops the display of the AI character display image by the character display unit 81, stops the output of the AI character output voice to the speaker 85, or stops the behavior of the manipulator 82 as the AI character. Therefore, the front desk robot 13 no longer functions as the AI character, and the AI character is transferred to the management system 11.

As described above, the front desk robot 13 becomes the AI character and performs the instructed front desk task on the basis of the task execution instruction received from the management system 11.

In this manner, by performing the front desk task on the basis of the task execution instruction from the management system 11, it is possible to implement the customer service task with higher empathy.

Note that, also in a case where the front desk task is performed by the front desk terminal 12, processing similar to the front desk task control processing described with reference to FIG. 7 is performed by the management system 11, and processing similar to the front desk task execution processing described with reference to FIG. 8 is performed in the front desk terminal 12.

Note that, in such a case, since the manipulator is not provided on the front desk terminal 12, the task execution instruction including the AI character display image and the AI character output voice but not including the AI character operation information is generated at step S14 of the front desk task control processing. Furthermore, the AI character display image is an image of the upper body of the AI character and the like.

### <Regarding Guide Robot>

Next, the guide robot 14 will be described.

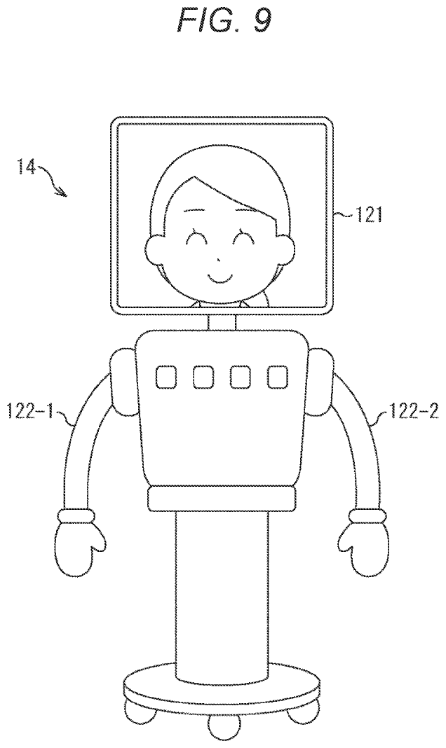

The guide robot 14 has an appearance as illustrated in FIG. 9, for example. In this example, the guide robot 14 is a humanoid robot device capable of autonomously traveling.

A character display unit 121 including a display and the like is provided at a position corresponding to a head of the humanoid guide robot 14, and the AI character display image is displayed on the character display unit 121.

In the guide robot 14 also, as in a case with the front desk robot 13, the head of the AI character is displayed as the AI character display image, and the AI character display image and a portion below the head of the guide robot 14 form the AI character as a whole.

Furthermore, the guide robot 14 includes a manipulator 122-1 and a manipulator 122-2 functioning as arms, hands and the like of the AI character. Note that, hereinafter, in a case where the manipulator 122-1 and the manipulator 122-2 are not especially required to be distinguished from each other, they will also be simply referred to as the manipulators 122.

With the guide robot 14, the behavior of the AI character is effectively implemented by cooperation (linkage) between the display of the AI character display image and movement of the manipulator 122.

Furthermore, by using the manipulator 122, not only the behavior of the AI character is performed but also a load of the customer can be transported. Note that, the guide robot 14 is not necessarily provided with the manipulator 122.

For example, although FIG. 9 illustrates an example in which the guide robot 14 is close to a human life-size, the guide robot 14 may be a robot device of a cart type and the like without the manipulator 122.

In addition, similarly to a case with the front desk robot 13, the guide robot 14 cooperates with the customer response integration unit 25 of the management system 11 to guide the customer and perform the interaction such as the chat through the in-facility guide task.

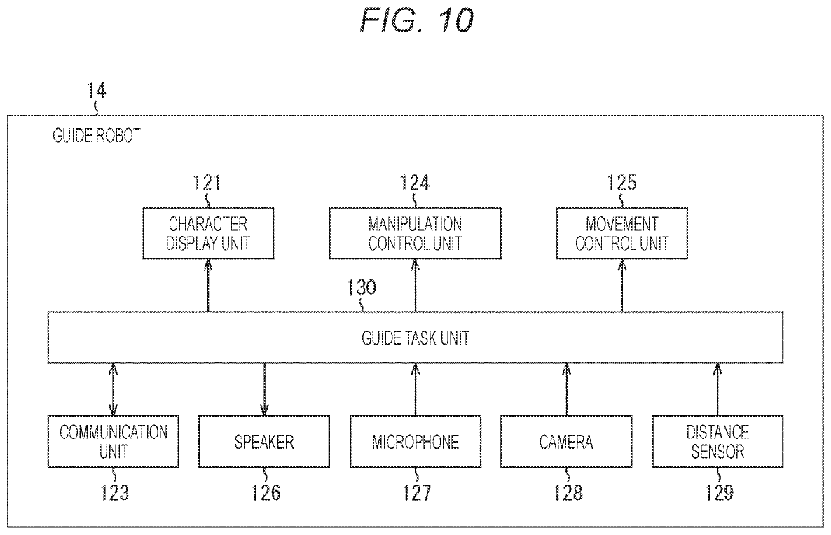

FIG. 10 is a diagram illustrating a functional configuration example of the guide robot 14. Note that, in FIG. 10, portions corresponding to those in a case of FIG. 9 are denoted by the same reference signs, and the description thereof will be omitted as appropriate.

In this example, the guide robot 14 includes the character display unit 121, a communication unit 123, a manipulation control unit 124, a movement control unit 125, a speaker 126, a microphone 127, a camera 128, a distance sensor 129, and a guide task unit 130.

The communication unit 123 supplies the AI character display image, the AI character output voice, and the AI character operation information transmitted from the management system 11 to the guide task unit 130, and transmits the customer face image and customer voice supplied from the guide task unit 130 to the management system 11.

The manipulation control unit 124 allows the guide robot 14 to perform a predetermined operation by driving the manipulator 122 on the basis of the AI character operation information supplied from the guide task unit 130.

The movement control unit 125 moves the guide robot 14 by driving a drive unit such as a motor that rotates wheels provided on the guide robot 14 on the basis of drive information supplied from the guide task unit 130.

The speaker 126 outputs the AI character output voice supplied from the guide task unit 130. The microphone 127 collects the voice of the surrounding customer as the customer voice and supplies the same to the guide task unit 130. The camera 128 captures various images such as the customer face image with the customer as the subject and supplies the same to the guide task unit 130.

The distance sensor 129 measures a distance to the customer and supplies a measurement result to the guide task unit 130. The guide task unit 130 performs the in-facility guide task by controlling an entire operation of the guide robot 14. That is, the guide task unit 130 cooperates with the customer response integration unit 25 of the management system 11 to perform the interaction with the customer and move in the facility and the like, thereby performing the in-facility guide task.

In a case where the management system 11 instructs the guide robot 14 as described above to execute the in-facility guide task, the management system 11 performs the in-facility guide task control processing similar to the front desk task control processing described with reference to FIG. 7.

Note that, processes at steps S11 and S12 are not performed, and processes corresponding to step S13 to step S15 are performed in the in-facility guide task control processing. Especially, in the process corresponding to step S14, execution of the in-facility guide task is instructed. Furthermore, here, it is assumed that a target customer and the AI character defined by the customer are already specified.

In the process corresponding to step S13 in the in-facility guide task control processing, the AI character display image corresponding to the type (type) of the customer service device being the guide robot 14, the arrangement position of the character display unit 121 in the guide robot 14, the design of the entire guide robot 14 and the like is generated.

Specifically, for example, in a case where the guide robot 14 is a humanoid and the character display unit 121 is arranged at the head position, an image of the head of the AI character having a size corresponding to a life-size of the guide robot 14 is generated as the AI character display image.

In contrast, for example, in a case where the guide robot 14 is a robot device different from the humanoid, an image of an AI character imitating a figure riding on a cockpit and the like is generated as the AI character display image.

Furthermore, for example, when generating the AI character output voice, the interactive AI unit 24 also uses the customer interaction information updated at the time of the front desk task execution processing. In other words, for the generation of the AI character output voice of the guide robot 14 that functions as the AI character and performs the interaction with the customer, information obtained by the interaction with the customer by the front desk robot 13 and the like that functions as the AI character before the guide robot 14 is also used.

Therefore, when the in-facility guide task is performed, the content of the interaction such as the chat at the time of the front desk task performed before the in-facility guide task is taken over, and the interaction based on the content of the interaction is performed. Therefore, it is possible to implement the interaction with higher empathy.

Moreover, for example, the AI character operation information includes route information indicating a route in the accommodation facility along which the guide robot 14 should proceed at the time of in-facility guide task, that is, at the time of guidance to the guest room and the like, moving speed information indicating a basic moving speed of the guide robot 14 at the time of guidance and the like.

In this case, the interactive AI unit 24 generates the moving speed information on the basis of the age of the customer obtained by the customer accommodation information, the customer information, the interaction at the time of the front desk task and the like.

Therefore, the guide robot 14 guides (guides) the customer to the guest room and the like while moving at the moving speed determined for the age of the customer. That is, the guide robot 14 can guide in a state in which an appropriate distance not too far from the customer is maintained. As a result, it is possible to implement the customer service with higher satisfaction.

Furthermore, in the in-facility guide task control processing, the task execution instruction is transmitted to the guide robot 14, so that the guide robot 14 functions as the AI character defined by the customer. Therefore, the AI character is taken over (switched) from the front desk terminal 12 or the front desk robot 13 to the guide robot 14.

When such in-facility guide task control processing is performed, the guide robot 14 performs the in-facility guide task execution processing similar to the front desk task execution processing described with reference to FIG. 8.

For example, in the process corresponding to step S42 in the in-facility guide task execution processing, the guide task unit 130 supplies the AI character display image to the character display unit 121 to display, and supplies the AI character output voice to the speaker 126 to output.

Furthermore, the guide task unit 130 supplies the AI character operation information to the manipulation control unit 124 to allow the manipulator 122 to perform a behavior (operation) such as a gesture as the AI character, or to carry a load of the customer.

Moreover, the guide task unit 130 generates the drive information on the basis of the route information and moving speed information included in the AI character operation information, a measurement result from the distance sensor 129 and the like and supplies the same to the movement control unit 125. The movement control unit 125 drives the drive unit such as the motor on the basis of the drive information from the guide task unit 130 to move the guide robot 14.

Therefore, the guide robot 14 can guide (guide) the customer to the guest room and the like while maintaining an appropriate distance from the customer while performing the chat with the customer or guidance in the accommodation facility by voice while implementing the behavior of the AI character and the transportation of the load by the cooperation between the display of the AI character display image and the movement of the manipulator 122.

In this case, the guide robot 14 basically moves at the moving speed indicated by the moving speed information, but the guide task unit 130 generates the drive information while finely adjusting the moving speed on the basis of the measurement result of the distance to the customer supplied from the distance sensor 129.

Specifically, for example, the guide task unit 130 determines a correction value of the moving speed of the guide robot 14 so that the distance from the guide robot 14 to the customer becomes a predetermined distance determined in advance, and generates the drive information for moving at the moving speed corrected by the correction value. Therefore, the guide robot 14 can move slightly in front of the customer so as not to be too far from the customer, for example.

Note that, although the example in which the moving speed information is generated by the interactive AI unit 24 is herein described, the guide task unit 130 may determine the moving speed on the basis of the age of the customer and the measurement result of the distance to the customer, and generate the drive information according to the moving speed. Furthermore, the measurement result of the distance may be supplied to the interactive AI unit 24, and the interactive AI unit 24 may generate the moving speed information in consideration of the measurement result of the distance.

### <Regarding Guest Room Terminal>

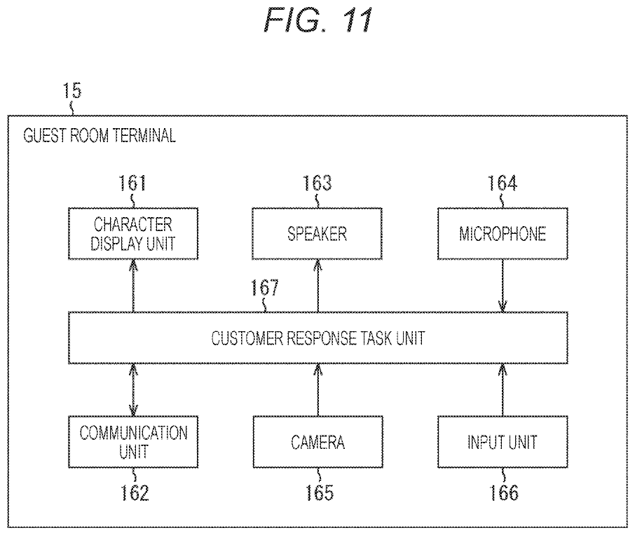

The guest room terminal 15 includes, for example, a terminal having a telephone function and the like, and is configured as illustrated in FIG. 11.

In this example, the guest room terminal 15 includes a character display unit 161, a communication unit 162, a speaker 163, a microphone 164, a camera 165, an input unit 166, and a customer response task unit 167.

The character display unit 161 includes a display and the like, and displays various images such as the AI character display image and a menu of the room service supplied from the customer response task unit 167. For example, in the character display unit 161, an image of the entire AI character is displayed as the AI character display image.

The communication unit 162 supplies the AI character display image and the AI character output voice transmitted from the management system 11 to the customer response task unit 167, and transmits the customer face image and the customer voice supplied from the customer response task unit 167 to the management system 11.

The speaker 163 outputs the AI character output voice supplied from the customer response task unit 167. The microphone 164 collects the voice of the surrounding customer as the customer voice and supplies the same to the customer response task unit 167. The camera 165 captures the customer face image with the customer as the subject and supplies the same to the customer response task unit 167.

The input unit 166 includes a button, a switch, a touch panel superimposed on the character display unit 161 and the like, and supplies a signal corresponding to an operation of the customer to the customer response task unit 167.

The customer response task unit 167 performs the customer response task by controlling an entire operation of the guest room terminal 15. That is, the customer response task unit 167 performs the customer response task by performing the interaction with the customer, information provision, order acceptance of the room service and the like in cooperation with the customer response integration unit 25 of the management system 11.

In a case where the management system 11 instructs the guest room terminal 15 to execute the customer response task, the management system 11 performs the customer response task control processing similar to the front desk task control processing described with reference to FIG. 7.

Note that, processes at steps S11 and S12 are not performed, and processes corresponding to step S13 to step S15 are performed in the customer response task control processing. Especially, in the process corresponding to step S14, an instruction is issued to execute the customer response task. Furthermore, here, it is assumed that a target customer and the AI character defined by the customer are already specified.

In the process corresponding to step S13 in the customer response task control processing, the AI character output voice is generated by also using the customer interaction information updated when executing the customer service task performed so far, that is, the front desk task and the in-facility guide task. Therefore, it is possible to implement an interaction with higher empathy based on the content of the interaction with the customer so far.

Furthermore, when there is a request for information provision from the customer, such as provision of map information around the accommodation facility, the customer response integration unit 25 generates the task execution instruction including information for provision of the map information and the like in response to the request of the customer, and transmits the same to the guest room terminal 15 via the communication unit 26.

When such customer response task control processing is performed, the guest room terminal 15 performs the customer response task execution processing similar to the front desk task execution processing described with reference to FIG. 8.

For example, in the process corresponding to step S42 in the customer response task execution processing, the customer response task unit 167 supplies the various pieces of information such as the AI character display image and the map information to be provided to the customer to the character display unit 161 to display, and supplies the AI character output voice to the speaker 163 to output to perform the customer response task.

Furthermore, for example, when the order for the room service is made by the customer operating the input unit 166 and the like, the customer response task unit 167 generates order information indicating the content of the order made by the customer on the basis of a signal supplied from the input unit 166. The customer response task unit 167 supplies the order information to the communication unit 162 to transmit to the management system 11.

Then, in the management system 11, the communication unit 26 receives the order information transmitted from the guest room terminal 15, and supplies the same to the customer response integration unit 25. Upon receiving the order information, the customer response integration unit 25 updates the customer information and the customer accommodation information on the basis of the order information as necessary, and presents the order information to the kitchen, the front desk and the like.

Furthermore, when the food and drink and the like ordered by the customer is placed on the room service robot 16, the management system 11 performs room service task control processing to be described later, and allows the room service robot 16 to perform the room service task.

Note that, the acceptance of the order for the room service by the guest room terminal 15 is a customer response task, but can also be said to be a part of the room service task.

### <Regarding Room Service Robot>

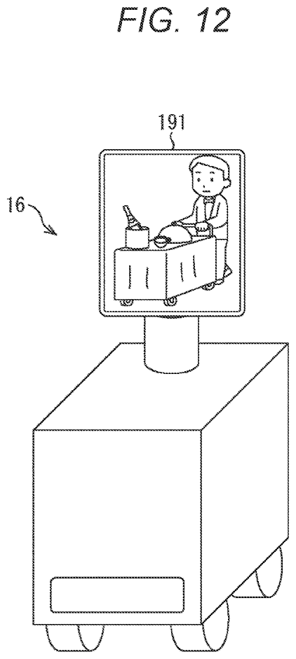

The room service robot 16 has an appearance as illustrated in FIG. 12, for example. In this example, the room service robot 16 is a robot device of a cart type and the like capable of autonomously traveling.

A character display unit 191 including a display and the like is provided on an upper portion of a wagon portion (meal serving table portion) on which the food and drink and the like may be loaded of the room service robot 16, and the AI character display image is displayed on the character display unit 191.

For example, in the room service robot 16, the image of the AI character imitating a figure riding on a cockpit, an image of the entire body of the AI character carrying ordered food and drink and the like with a wagon and the like are displayed as the AI character display image.

The room service robot 16 performs the room service task of transporting food and drink and the like to the guest room of the customer on the basis of the task execution instruction from the customer response integration unit 25 in a state in which the food and drink and the like of the room service ordered by the customer is placed.

At the time of room service task, for example, the AI character is displayed on the character display unit 191, and a state of transportation (delivery) of food and drink and the like by the room service robot 16 is displayed on the character display unit 161 and the like of the guest room terminal 15. That is, how the ordered food and drink and the like is transported is relayed to the guest room of the customer by the management system 11.

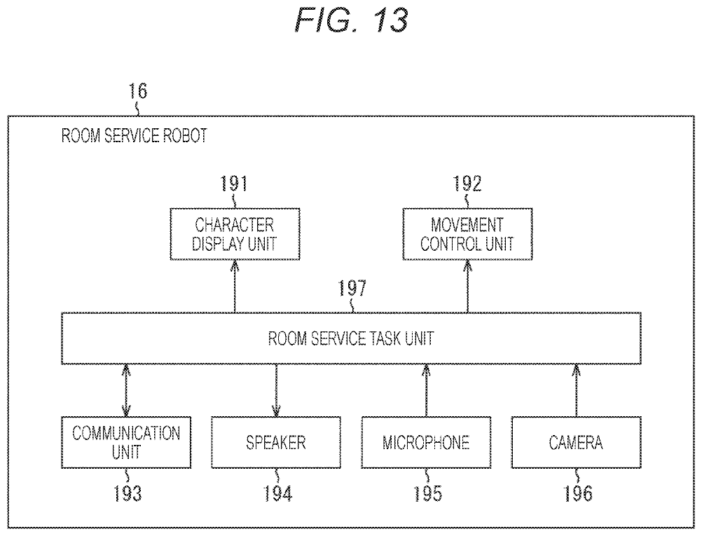

FIG. 13 is a diagram illustrating a functional configuration example of the room service robot 16. Note that, in FIG. 13, portions corresponding to those in a case of FIG. 12 are denoted by the same reference numerals, and the description thereof will be omitted as appropriate.

In this example, the room service robot 16 includes the character display unit 191, a movement control unit 192, a communication unit 193, a speaker 194, a microphone 195, a camera 196, and a room service task unit 197.

The movement control unit 192 moves the room service robot 16 by driving a drive unit such as a motor that rotates wheels provided on the room service robot 16 on the basis of drive information supplied from the room service task unit 197.

The communication unit 193 supplies the AI character display image, the AI character output voice, and the AI character operation information transmitted from the management system 11 to the room service task unit 197, and transmits a relay video and voice of the room service supplied from the room service task unit 197 to the management system 11.

The speaker 194 outputs the AI character output voice supplied from the room service task unit 197. The microphone 195 collects the surrounding voice and supplies the same to the room service task unit 197.

During movement of the room service robot 16 to the guest room, that is, during delivery, the camera 196 images food and drink and the like placed on the room service robot 16, a corridor around the same and the like as a subject, thereby imaging a state of transportation of the ordered food and drink and the like as the relay video of the room service. The camera 196 supplies the relay video obtained by imaging to the room service task unit 197.

The room service task unit 197 performs the room service task by controlling an entire operation of the room service robot 16. That is, the room service task unit 197 cooperates with the customer response integration unit 25 of the management system 11 to transport food and drink and the like to the guest room, captures the relay video and the like.

In a case where the management system 11 instructs the room service robot 16 as described above to execute the room service task, the management system 11 performs the room service task control processing similar to the front desk task control processing described with reference to FIG. 7.

Note that, processes at steps S11 and S12 are not performed, and processes corresponding to step S13 to step S15 are performed in the room service task control processing. Especially, in the process corresponding to step S14, an instruction is issued to execute the room service task is indicated. Furthermore, here, it is assumed that a target customer and the AI character defined by the customer are already specified.

In the process corresponding to step S13 in the room service task control processing, the AI character operation information including the route information similar to that at the time of the in-facility guide task is generated.

The customer response integration unit 25 generates the task execution instruction of the room service task including such AI character operation information, supplies the same to the communication unit 26, and transmits the same to the room service robot 16.

When the room service task control processing is performed, the room service robot 16 performs the room service task execution processing similar to the front desk task execution processing described with reference to FIG. 8.

For example, in the process corresponding to step S42 in the room service task execution processing, the room service task unit 197 supplies the AI character display image to the character display unit 191 to display.

Furthermore, the room service task unit 197 generates the drive information on the basis of the route information included in the AI character operation information, and supplies the same to the movement control unit 192. The movement control unit 192 drives the drive unit such as the motor on the basis of the drive information from the room service task unit 197 to move the room service robot 16 to the guest room.

Moreover, the camera 196 images a state of transportation of food and drink and the like as the relay video of the room service, and supplies the same to the room service task unit 197. The room service task unit 197 supplies the relay video supplied from the camera 196 to the communication unit 193 to transmit to the management system 11.

Then, in the management system 11, the customer response integration unit 25 supplies the relay video received from the room service robot 16 by the communication unit 26 to the communication unit 26 to transmit to the guest room terminal 15. In the guest room terminal 15, when the relay video transmitted from the management system 11 by the communication unit 162 is received, the relay video is supplied from the customer response task unit 167 to the character display unit 161, and the relay video is displayed. That is, the transporting state of the food and drink and the like of the room service is presented to the customer in the guest room. Note that, the relay video may be captured by the camera provided in the accommodation facility.

When arriving at the guest room of the customer, the room service robot 16 appropriately performs the interaction and the like with the customer that the order of the room service arrives. Then, when the delivery is completed, the room service robot 16 transmits the task completion report indicating that the room service task is completed to the management system 11. After the room service task is completed, the AI character in charge of the customer is taken over to the guest room terminal 15.

As a result, according to the present technology, it is possible to implement the customer service task with higher empathy.

Note that, in the above description, a case where the customer service task is performed in the accommodation facility such as the hotel or the inn is described as an example, but the present technology can be applied to provision of any service of a sports gym, a medical facility, a museum and the like as long as the customer service task is performed for a user by a plurality of customer service devices. The present technology is especially useful in a case where a plurality of customer service devices performs different tasks (customer service tasks).

### <Configuration Example of Computer>

Note that, the above-described series of processing may be executed by hardware or software. In a case where the series of processing is executed by the software, a program forming the software is installed on a computer. Here, examples of the computer include a computer incorporated in dedicated hardware, and for example, a general-purpose personal computer capable of executing various functions by installing various programs.

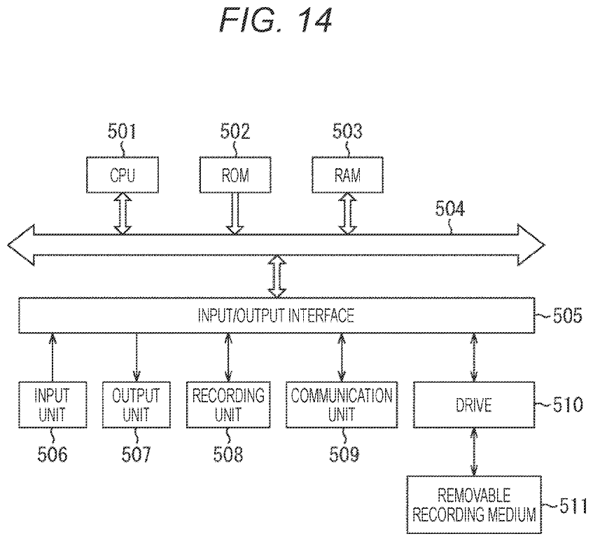

FIG. 14 is a block diagram illustrating a configuration example of hardware of a computer that executes the series of processing described above according to a program.

In the computer, a central processing unit (CPU) 501, a read only memory (ROM) 502, and a random access memory (RAM) 503 are mutually connected by a bus 504.

Moreover, an input/output interface 505 is connected to the bus 504. An input unit 506, an output unit 507, a recording unit 508, a communication unit 509, and a drive 510 are connected to the input/output interface 505.

The input unit 506 includes a keyboard, a mouse, a microphone, an imaging element and the like. The output unit 507 includes a display, a speaker and the like. The recording unit 508 includes a hard disk, a non-volatile memory and the like. The communication unit 509 includes a network interface and the like. The drive 510 drives a removable recording medium 511 such as a magnetic disk, an optical disk, a magneto-optical disk, or a semiconductor memory.

In the computer configured as described above, the CPU 501 loads, for example, a program recorded in the recording unit 508 into the RAM 503 via the input/output interface 505 and the bus 504, and executes the program, so as to execute the above-described series of processing.

The program executed by the computer (CPU 501) can be provided by being recorded on the removable recording medium 511 as a package medium and the like, for example. Furthermore, the program can be provided via a wired or wireless transmission medium such as a local area network, the Internet, or digital satellite broadcasting.

In the computer, the program can be installed in the recording unit 508 via the input/output interface 505 by mounting the removable recording medium 511 on the drive 510. Furthermore, the program can be received by the communication unit 509 via the wired or wireless transmission medium to be installed on the recording unit 508. In addition, the program can be installed in the ROM 502 or the recording unit 508 in advance.

Note that, the program to be executed by the computer may be a program that is processed in time series in the order described in the present specification, or may be a program that is processed in parallel or at required timings such as when a call is made.

Furthermore, the embodiments of the present technology are not limited to the above-described embodiments, and various modifications are possible without departing from the scope of the present technology.

For example, the present technology may employ a configuration of cloud computing in which one function is shared and processed in cooperation by a plurality of devices via a network.

Furthermore, each step described in the flowchart described above may be executed by one device, or may be executed in a shared manner by a plurality of devices.

Moreover, in a case where a plurality of pieces of processing is included in one step, the plurality of pieces of processing included in the one step can be executed by one device or shared to be executed by a plurality of devices.

Moreover, the present technology may also have following configurations.

(1)

An information processing device including:
a communication unit that communicates with a plurality of customer service devices that performs a customer service task for a user; and
a reception integration unit that allows a customer service device that is allowed to function as a character to perform an interaction based on information regarding the user and execute the customer service task for the user while switching the customer service device that is allowed to function as the character in such manner that any one of the plurality of customer service devices functions as one character defined for each user out of a plurality of characters.
   (2)

The information processing device according to (1), in which
the reception integration unit allows the customer service device that is allowed to function as the character to display an image of the character.
   (3)

The information processing device according to (2), in which
the reception integration unit allows display of an image of an entire body of the character or display of an image of a part of the character according to a type of the customer service device or a position of a display unit in the customer service device.
   (4)

The information processing device according to any one of (1) to (3), in which
the reception integration unit allows the customer service device that is allowed to function as the character to operate to perform a behavior different for each character.
   (5)

The information processing device according to (4), in which
at least one customer service device out of the plurality of customer service devices includes a manipulator, and
the reception integration unit allows movement of the manipulator to cooperate with display of an image of the character to implement a behavior for each character.
   (6)

The information processing device according to any one of (1) to (5), in which
the reception integration unit allows the customer service device that is allowed to function as the character to output a voice with a voice quality or a manner of speaking different for each character when the customer service device is allowed to perform the interaction.
   (7)

The information processing device according to any one of (1) to (6), in which
the plurality of customer service devices includes the customer service devices that perform customer service tasks different from each other.
   (8)

The information processing device according to any one of (1) to (7), in which
the customer service device is a terminal or a robot device.
   (9)

The information processing device according to any one of (1) to (8), further including:
a generation unit that generates a voice of the interaction on the basis of the information regarding the user.
   (10)

The information processing device according to any one of (1) to (9), in which
the information regarding the user is information including at least one of age, address, sex, request, preference, or interest of the user.
   (11)

The information processing device according to any one of (1) to (10), in which
the information regarding the user is information obtained by the interaction with the user.
   (12)

The information processing device according to (11), in which
the information regarding the user is information obtained by the interaction with the user by another customer service device that is allowed to function as the character before the customer service device that functions as the character and performs the interaction with the user.
   (13)

The information processing device according to any one of (1) to (12), in which
the information regarding the user is information obtained at the time of reservation of use of a service regarding the customer service task.
   (14)

The information processing device according to any one of (1) to (13), in which
the information regarding the user is information obtained at the time of past use of a service regarding the customer service task by the user.
   (15)

The information processing device according to any one of (1) to (14), in which
the customer service task is at least one of a front desk task, a guide task, a task to respond to a request of the user, or a room service task.
   (16)

An information processing method including:
communicating with a plurality of customer service devices that performs a customer service task for a user; and
allowing a customer service device that is allowed to function as a character to perform an interaction based on information regarding the user and execute the customer service task for the user while switching the customer service device that is allowed to function as the character in such a manner that any one of the plurality of customer service devices functions as one character defined for each user out of a plurality of characters
by an information processing device.
   (17)

A program that allows a computer to execute processing including steps of:
communicating with a plurality of customer service devices that performs a customer service task for a user; and
allowing a customer service device that is allowed to function as a character to perform an interaction based on information regarding the user and execute the customer service task for the user while switching the customer service device that is allowed to function as the character in such a manner that any one of the plurality of customer service devices functions as one character defined for each user out of a plurality of characters.

### REFERENCE SIGNS LIST

11 Management system
12 Front desk terminal
13 Front desk robot
14 Guide robot
15 Guest room terminal
16 Room service robot
22 Front desk system database
23 Information holding unit
24 Interactive AI unit
25 Customer response integration unit
26 Communication unit

1. An information processing device comprising:
a communication unit that communicates with a plurality of customer service devices that performs a customer service task for a user; and
a reception integration unit that allows a customer service device that is allowed to function as a character to perform an interaction based on information regarding the user and execute the customer service task for the user while switching the customer service device that is allowed to function as the character in such manner that any one of the plurality of customer service devices functions as one character defined for each user out of a plurality of characters.

2. The information processing device according to claim 1, wherein
the reception integration unit allows the customer service device that is allowed to function as the character to display an image of the character.

3. The information processing device according to claim 2, wherein
the reception integration unit allows display of an image of an entire body of the character or display of an image of a part of the character according to a type of the customer service device or a position of a display unit in the customer service device.

4. The information processing device according to claim 1, wherein
the reception integration unit allows the customer service device that is allowed to function as the character to operate to perform a behavior different for each character.

5. The information processing device according to claim 4, wherein
at least one customer service device out of the plurality of customer service devices includes a manipulator, and
the reception integration unit allows movement of the manipulator to cooperate with display of an image of the character to implement a behavior for each character.

6. The information processing device according to claim 1, wherein
the reception integration unit allows the customer service device that is allowed to function as the character to output a voice with a voice quality or a manner of speaking different for each character when the customer service device is allowed to perform the interaction.

7. The information processing device according to claim 1, wherein
the plurality of customer service devices includes the customer service devices that perform customer service tasks different from each other.

8. The information processing device according to claim 1, wherein
the customer service device is a terminal or a robot device.

9. The information processing device according to claim 1, further comprising:
a generation unit that generates a voice of the interaction on a basis of the information regarding the user.

10. The information processing device according to claim 1, wherein
the information regarding the user is information including at least one of age, address, sex, request, preference, or interest of the user.

11. The information processing device according to claim 1, wherein
the information regarding the user is information obtained by the interaction with the user.

12. The information processing device according to claim 11, wherein
the information regarding the user is information obtained by the interaction with the user by another customer service device that is allowed to function as the character before the customer service device that functions as the character and performs the interaction with the user.

13. The information processing device according to claim 1, wherein
the information regarding the user is information obtained at the time of reservation of use of a service regarding the customer service task.

14. The information processing device according to claim 1, wherein
the information regarding the user is information obtained at the time of past use of a service regarding the customer service task by the user.

15. The information processing device according to claim 1, wherein
the customer service task is at least one of a front desk task, a guide task, a task to respond to a request of the user, or a room service task.

16. An information processing method comprising:
communicating with a plurality of customer service devices that performs a customer service task for a user; and
allowing a customer service device that is allowed to function as a character to perform an interaction based on information regarding the user and execute the customer service task for the user while switching the customer service device that is allowed to function as the character in such a manner that any one of the plurality of customer service devices functions as one character defined for each user out of a plurality of characters
by an information processing device.

17. A program that allows a computer to execute processing including steps of:
communicating with a plurality of customer service devices that performs a customer service task for a user; and
allowing a customer service device that is allowed to function as a character to perform an interaction based on information regarding the user and execute the customer service task for the user while switching the customer service device that is allowed to function as the character in such a manner that any one of the plurality of customer service devices functions as one character defined for each user out of a plurality of characters.
